(19) United States
(12) Patent Application Publication
(10) Pub. No.: US 2007/0236854 A1
(43) Pub. Date: Oct. 11, 2007

(54) Anti-Gravity Device for Supporting Weight and Reducing Transmissibility

(76) Inventors: Martin E. Lee, San Jose, CA (US); Bausan Yuan, San Jose, CA (US); Susumu Makinouchi, Zama-shi (JP)

Correspondence Address: AKA CHAN LLP, 900 LAFAYETTE STREET, SUITE 710, SANTA CLARA, CA, 95050, US

(21) Appl. No.: 11/279,296

(22) Filed: Apr. 11, 2006

(51) Int. Cl. H01H 47/00

(52) U.S. Cl. 361/143

(57) ABSTRACT

Methods and apparatus for supporting the weight of a first stage of a stage apparatus using magnets are disclosed. According to one aspect of the present invention, and apparatus includes a first structure, a second structure, and an anti-gravity device. The anti-gravity device has a first magnet and a piston arrangement that includes a second magnet. The first magnet is coupled to the first structure, and the piston arrangement is movably interfaced with the second structure through an air bearing. The first magnet and the piston arrangement cooperate to support the first structure over the second structure relative to a vertical axis.

### BACKGROUND OF THE INVENTION

1. Field of Invention

The present invention relates generally to devices which support structures against the forces of gravity. More particularly, the present invention relates to a magnet-based device which is suitable for supporting the weight of a structure associated with a photolithography apparatus without allowing for a significant transmission of vibrations to the structure.

2. Description of the Related Art

For many machines or instruments such as photolithography machines which are used in semiconductor processing, there is typically a need to enable components of the machines to move relative to a vertical axis. By way of example, for a stage apparatus that includes a fine positioning stage, the ability to move the fine positioning stage along a vertical axis allows the position of an object such as a reticle or a wafer to be fine tuned.

FIG. 1 is a block diagram representation of a stage apparatus. A stage apparatus 100 includes a coarse stage 108 and a fine stage 104. Fine stage 104 is generally supported atop coarse stage 108 such that fine stage 104 may move with coarse stage 108 as well as independently of coarse stage 108. Fine stage 104 may be capable of translational movement in up to three degrees of freedom, and may also be capable of rotational movement in up to three degrees of freedom. The translational degrees of freedom are generally horizontal degrees of freedom associated with an x-axis 110a and a y-axis, and a vertical degree of freedom associated with a z-axis 110c. The rotational degrees of freedom are relative to x-axis 110a, y-axis 110b, and z-axis 110c.

In order for fine stage 104 to move either translationally along or rotationally about z-axis 110c relative to coarse stage 108, fine stage 104 generally must be supported relative to z-axis 110c. That is, anti-gravity compensation is typically provided to support fine stage 104 relative to a vertical degree of freedom.

Linkages (not shown) which include any combination of gimbal mounts, air bearings, and guides generally mechanically couple fine stage 104 to coarse stage 108. While effective in supporting the weight of fine stage 104 against gravity forces, such linkages are typically relatively stiff. Hence, due to stiffness associated with the linkages, many vibrations associated with coarse stage 108 may be transmitted to fine stage 104 via the linkages. As fine stage 104 is generally used to precisely position an object supported thereon, when fine stage 104 experiences vibrations, the accuracy with which fine stage 104 may position the object is compromised.

Many conventional devices, as for example electronic devices, which may provide support for a stage against gravity forces typically cause a significant amount of heat to be generated. The generation of heat often has an adversely effect on the performance of a stage device, as the accuracy with which a stage may position an object may be compromised.

Therefore, what is needed is a method and an apparatus that provides anti-gravity support for a fine stage without significant heat generation and without causing vibrations to be transmitted from a coarse stage to the fine stage. That is, what is desired is a system with relatively low stiffness which supports the weight of a structure such as a fine stage against gravity forces.

### SUMMARY OF THE INVENTION

The present invention relates to an anti-gravity device which utilizes magnets to support the weight of a first stage over a second stage. According to one aspect of the present invention, and apparatus includes a first structure, a second structure, and an anti-gravity device. The anti-gravity device has a first magnet and a piston arrangement that includes or is coupled to a second magnet. The first magnet is coupled to the first structure, and the piston arrangement is movably interfaced with the second structure through an air bearing. The first magnet and the piston arrangement cooperate to support the first structure over the second structure relative to a vertical axis.

In one embodiment, the first magnet has a first magnet pole of a first polarity and the second magnet has a second magnet pole of the first polarity. In such an embodiment, the first magnet pole opposes the second magnet pole and an overall repulsive force is associated with the first magnet and the second magnet. A vacuum force may balance the overall repulsive force to support the first structure over the second structure.

An anti-gravity device that uses magnets which generate magnet forces, e.g., repulsive forces, that are balanced by vacuum or air pressure forces allows a first structure such as a fine stage to be supported over a second structure such as a coarse stage. Such an anti-gravity device has a low associated stiffness and, hence, provides for relatively low transmissibility between the second structure and the first structure. As an anti-gravity device that uses magnets is relatively small and may provide a clearance between the first structure and the second structure, the use of such an anti-gravity device allows the first structure to move in up to six degrees of freedom substantially without requiring time-consuming alignment processes.

According to another aspect of the present invention, a stage apparatus includes a first stage arrangement that supports an object to be positioned, a second stage arrangement, and an anti-gravity device. The anti-gravity device includes a first magnet and a piston arrangement that includes a second magnet. The first magnet is coupled to the first stage arrangement, and the piston arrangement is movably interfaced with the second stage arrangement through an air bearing. The first magnet and the piston arrangement cooperate to support the first stage arrangement over the second stage arrangement relative to a vertical axis such that the first stage arrangement may move both with the second stage arrangement and substantially without mechanical contact to the second stage arrangement.

In one embodiment, the first magnet has at least one horizontal dimension that is not equal to a corresponding horizontal dimension of the second magnet. In another embodiment, the first stage arrangement is arranged to move in up to six degrees of freedom substantially independently of the second stage arrangement.

According to still another aspect of the present invention, a method for controlling a vertical position of a first stage arrangement relative to a second stage arrangement using an anti-gravity device that includes a first magnet coupled to the first stage arrangement and a piston arrangement that includes a second magnet, and is interfaced with the second stage arrangement through an air bearing, includes generating a magnet force relative to the first magnet and the second magnet. A balancing force is generated in response to the magnet force. The balancing force and the magnet force cooperate to support the first stage arrangement over the second stage arrangement. In one embodiment, the magnet force is a repulsive force and the balancing force is a vacuum force. In another embodiment, the magnet force is an attractive force and the balancing force is a pressure force.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a block diagram representation of a stage apparatus.

FIG. 2 is a block diagram representation of a stage apparatus with a magnetic anti-gravity device in accordance with an embodiment of the present invention.

FIG. 3 is a diagrammatic cross-sectional side-view representation of an anti-gravity device which includes a piston arrangement that utilizes repelling magnets and a vacuum in accordance with an embodiment of the present invention.

FIG. 4 is a diagrammatic cross-sectional side-view representation of an anti-gravity device with a closed vacuum arrangement in accordance with an embodiment of the present invention.

FIG. 5 is a diagrammatic cross-sectional side-view representation of an anti-gravity device with a frame that separates a first magnet from a second magnet in accordance with an embodiment of the present invention.

FIG. 6 is a block diagram representation of a stage apparatus that includes a fine stage with up to approximately six degrees of freedom and an anti-gravity device with magnets and a piston arrangement in accordance with an embodiment of the present invention.

FIG. 7 is a diagrammatic cross-sectional side-view representation of an anti-gravity device with a magnet coupled to a structure supported by the anti-gravity device having larger dimensions than a magnet coupled to a piston arrangement of the anti-gravity device.

FIG. 8 is a diagrammatic representation of a photolithography apparatus in accordance with an embodiment of the present invention.

FIG. 9 is a process flow diagram which illustrates the steps associated with fabricating a semiconductor device in accordance with an embodiment of the present invention.

FIG. 10 is a process flow diagram which illustrates the steps associated with processing a wafer, i.e., step 1304 of FIG. 9, in accordance with an embodiment of the present invention.

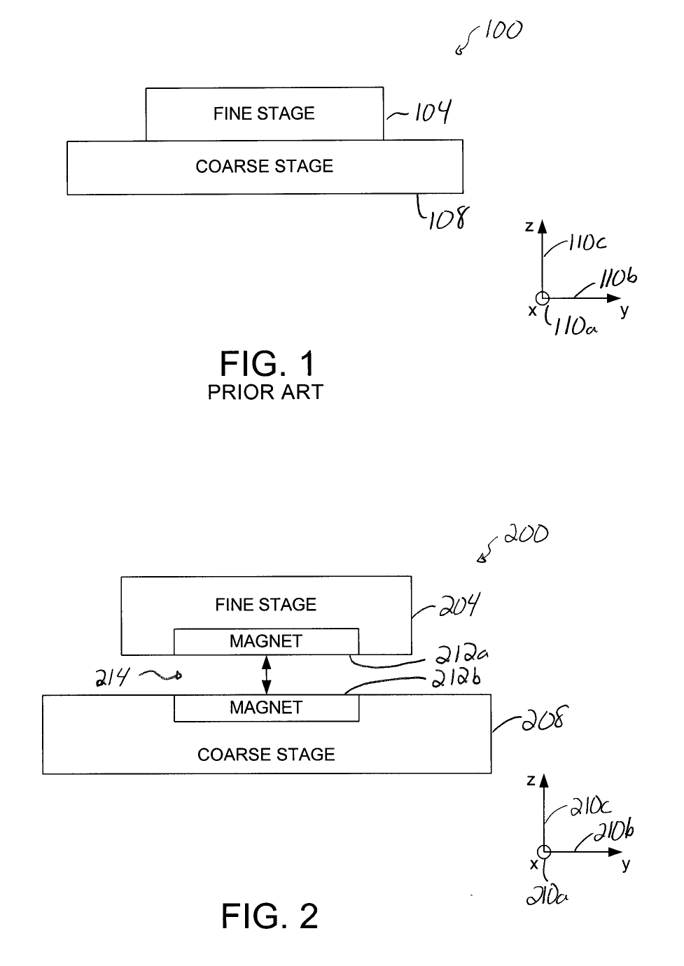

### DETAILED DESCRIPTION

In photolithography systems, anti-gravity support for fine stages that have a vertical degree of freedom is crucial. Anti-gravity support is often provided using linkages and gimbals. While linkages and gimbals are generally effective in supporting the weight of fine stages, linkages cause oscillations or vibrations to be transmitted to the fine stages, thereby adversely affecting the precision with which the fine stages may be positioned.

An anti-gravity device that utilizes forces generated by magnets to allow a fine stage to effectively float over a coarse stage provides support for the weight of fine stage without utilizing mechanical linkages or couplings. A first magnet is effectively coupled to the fine stage, and a second magnet may be part of a piston arrangement that is incorporated into a coarse stage arrangement such that the force between the two magnets is substantially balanced using the piston arrangement. When the force, e.g., the repulsive force, between the two magnets is balanced using the piston arrangement, e.g., a vacuum force associated with the piston arrangement, the weight of the fine stage is supported. As the transmissibility associated with such an anti-gravity device is relatively low due to a low stiffness associated with the anti-gravity device, the transmission of any vibrations associated with the coarse stage arrangement to the fine stage may be relatively low.

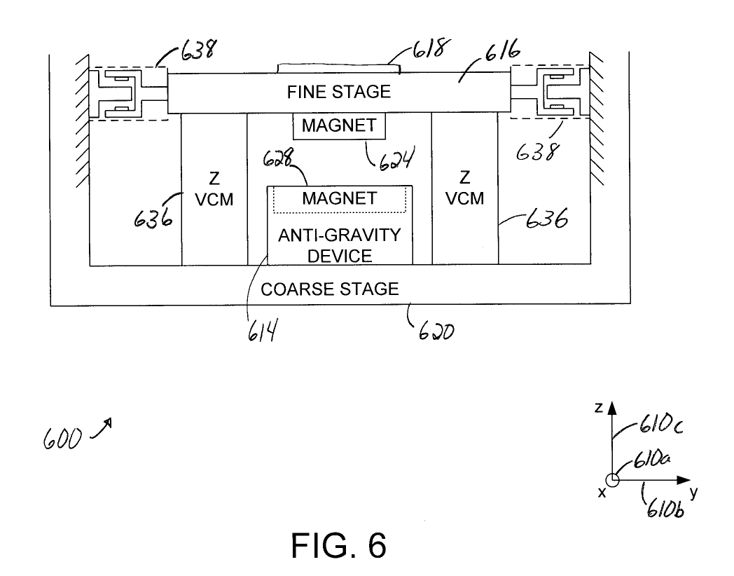

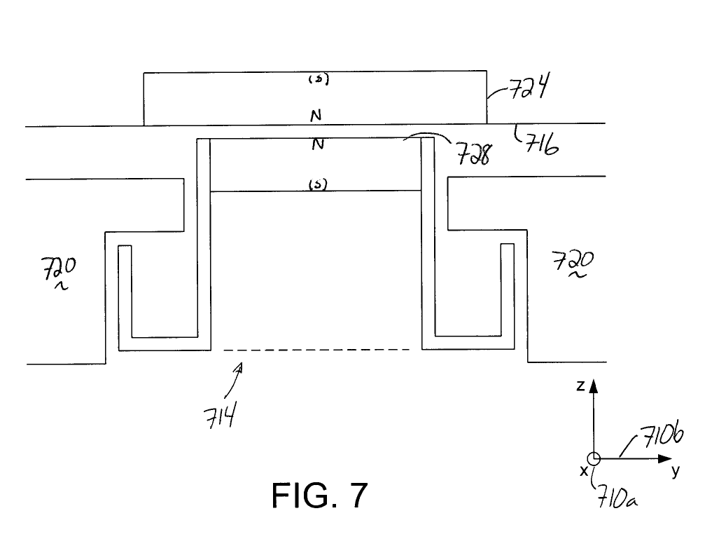

FIG. 2 is a block diagram representation of a stage apparatus which utilizes a magnetic anti-gravity device to support weight and to reduce transmissibility, e.g., the transmission of vibrations, in accordance with an embodiment of the present invention. A stage apparatus 200 includes a fine stage 204 that is supported over a coarse stage 208. Coarse stage 208 is arranged to move relative to an x-axis 210a, a y-axis 210b, and a z-axis 210c. When coarse stage 208 moves, fine stage 204 is carried along with coarse stage 208. The movement of a fine stage when a coarse stage moves is shown more clearly in FIG. 6 below. Fine stage 204 is also arranged to move independently of coarse stage 208, as for example to precisely position an object (not shown) supported on fine stage 204 after the object is coarsely positioned using coarse stage 208.

To provide anti-gravity support for fine stage 204 such that the weight of fine stage 204 is supported relative to z-axis 210c, an anti-gravity device 214 that includes magnet arrangements 212a, 212b. A first magnet arrangement 212a is arranged to be supported by, e.g., coupled to, fine stage 204, while a second magnet arrangement 212b is arranged to be supported by coarse stage 208. Magnet arrangements 212a, 212b may each include a single magnetic block and the size of magnet arrangements 212a, 212b may vary widely. Magnet arrangements 212a, 212b are arranged such that magnetic forces between first magnet arrangement 212a and second magnet arrangement 212b effectively cause fine stage 204 to “levitate” or float above coarse stage 208. By way of example, if first magnet arrangement 212a is arranged to have a north pole that opposes a north pole of second magnet arrangement 212b, a repulsive forces between first magnet arrangement 212a and second magnet arrangement 212b may push fine stage 204 away from coarse stage 208. A piston arrangement (not shown) may be incorporated into stage apparatus 200 to allow the repulsive forces between magnet arrangements 212a, 212b to be substantially balanced. Hence, the weight of fine stage 204 is effectively supported along z-axis 210c by the force created between first magnet arrangement.

As there is no mechanism such as a linkage between fine stage 204 and coarse stage 208, the transmission of vibrations associated with coarse stage 208 to fine stage 204 through anti-gravity device 214 may be relatively insignificant. Further, the lack of a mechanism such as a guide linkage that physically couples fine stage 204 to coarse stage 208 facilitates tilting and rotation of fine stage 204, and substantially eliminates a requirement of aligning fine stage 204 relative to coarse stage 208.

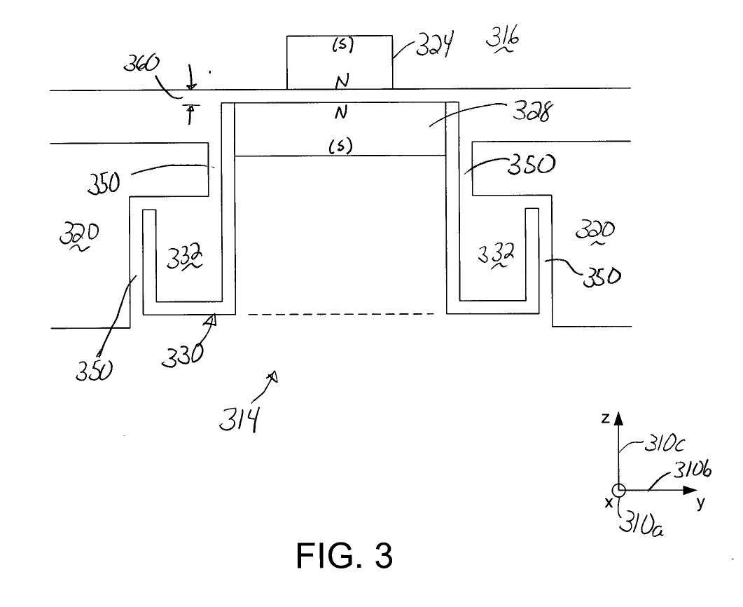

A piston arrangement of an anti-gravity device may be used, as previously mentioned, to allow magnetic forces associated with the anti-gravity device to be balanced. In general, a piston arrangement may be balanced using either a vacuum or a With reference to FIG. 3, an anti-gravity device which includes a piston arrangement that utilizes a vacuum will be described in accordance with an embodiment of the present invention. An anti-gravity device 314 includes a piston arrangement 330, a first magnet 324, and a second magnet 328. Since anti-gravity device 314 includes relatively few mechanical components, oscillations associated with anti-gravity device 314 are generally minimal. The polarity of magnets 324, 328 is such that the pole of magnet 324 has the same polarity as the pole of magnet 328, which opposes magnet 324. Hence, repulsive forces associated with magnets 324, 328 are such that magnet 324 and magnet 328 effectively push away from each other relative to a z-direction 310c. That is, magnet 324 is arranged to repel magnet 328, and vice versa. While magnets 324, 328 are shown as having north poles that are in opposition, it should be appreciated that magnets 324, 328 may instead have south poles that are in opposition.

Magnet 324 is coupled to a structure 316 that is intended to substantially float above a second structure 320. In the described embodiment, first structure 316 may be a fine stage that supports a reticle or a wafer (not shown) while second structure 320 may be a coarse stage. Magnet 328 is coupled to or otherwise supported on a piston arrangement 330. In one embodiment, magnet 328 is a part of piston arrangement 330. Magnet 324 and magnet 328 are separated by a relatively small gap 360. The size of gap 360 may vary widely. For example, gap 360 may be sized to be large enough for magnet 324 and magnet 328 to have clearance, while still being small enough to allow a sufficient lifting force to be generated.

Air bearings 350 allow piston arrangement 330 to move, as for example in z-direction 310c, within second structure 320 substantially without friction. Typically, air bearings 350 are “no contact” air bearings. Areas 332 of piston arrangement 330 are arranged to be substantially filled with a vacuum. An overall magnet force associated with magnets 324, 328 is arranged to be substantially equal in magnitude to a force associated with the vacuum in areas 332. By controlling the vacuum provided in areas 332 and the relative sizes of magnets 324, 328 such that the force associated with the vacuum is approximately equal to the weight of first structure 316, first structure 316 may be balanced substantially such that first structure 316 floats above second structure 320.

When magnet 324 repels magnet 328 by generating a downward force, e.g., a downward force relative to z-direction 310c, piston arrangement 330 is effectively pushed down. The vacuum force in areas 332 generally balances the force on piston arrangement 330 such that when piston arrangement 330 moves in a downward z-direction 310c, the vacuum force in areas 332 increases to compensate for the downward movement of piston arrangement 330 in a partial vacuum, while vacuum force in areas 332 remains substantially constant in a full vacuum. Areas 332 are compartments that have an associated volume. It should be appreciated that the volume generally reduces as piston arrangement 330 moves vertically upwards.

Anti-gravity device 314 generally has an associated stiffness. As will be appreciated by those skilled in the art, stiffness is related to transmissibility such that a low stiffness is associated with a low transmissibility. Stiffness may be expressed as a force divided by a displacement such that the total stiffness of anti-gravity device 314 is a function of the stiffness of magnets 324, 328 and the stiffness of the vacuum in areas 332. In one embodiment, the inverse of the total stiffness is approximately equal to the inverse of the stiffness of magnets 324, 328 summed with the inverse of the stiffness of the vacuum. The total stiffness of anti-gravity device 314 is relatively low. In particular, the stiffness of the vacuum is relatively low, as stiffness of vacuum and air is based on air molecules, and the number of air molecules in a vacuum is generally low. Hence, there is low transmissibility between second structure 320 and first structure 316.

The sizes of magnets 324, 328 may vary widely. As shown, first magnet 324 is smaller at least in a dimension relative to a y-direction 310b than second magnet 328. When second magnet 328 has a larger dimension relative to y-direction 310b than first magnet 324, translation of first structure 316 relative to y-direction 310b may occur substantially always with first magnet 324 opposing second magnet 328, i.e., without a significant change in magnet flux. Similarly, first magnet 324 may be smaller in a dimension relative to an x-direction 310a than second magnet 328 to facilitate translation relative to x-direction 310a. It should be appreciated that, in general, the sizes of magnets 324, 328 may generally be chosen such that the opposing forces associated with magnets 324, 328 is large enough to maintain a gap during motions of the stages to which magnets 324, 328 are coupled.

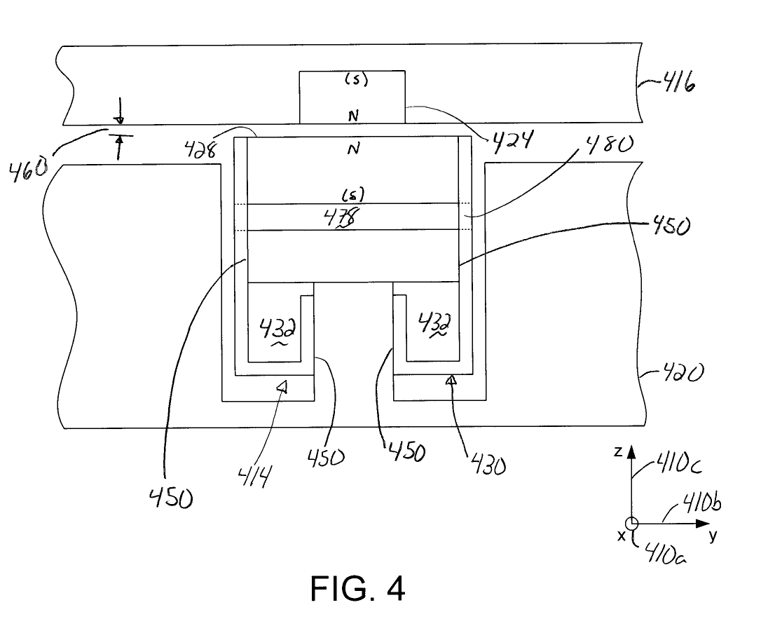

The configuration of an anti-gravity device which utilizes magnets may vary widely. By way of example, a piston arrangement may have vacuum-containing areas that are substantially closed relative to the piston arrangement. FIG. 4 is a diagrammatic cross-sectional side-view representation of an anti-gravity device with a closed vacuum arrangement in accordance with an embodiment of the present invention. An anti-gravity device 414 includes a first magnet 424 that is substantially coupled to a first structure 416 that is supported over a second structure 420. First structure 416 may be a fine stage while second structure 420 may be a coarse stage. Anti-gravity device 414 also includes a second magnet 428 that is supported within a piston arrangement 430. Air bearings 450 act as an interface between piston arrangement 430 and second structure 420, and also enable piston arrangement 430 to move relative to second structure 420 in a z-direction 410c substantially without friction.

First magnet 424 and second magnet 428 are each shown as having north poles that are in opposition, although it should be understood that first magnet 424 and second magnet 428 may instead each have south poles that are in opposition. Repulsive forces between first magnet 424 and second magnet 428, which are separated by a gap 460, typically cause piston arrangement 430 to move relative to z-axis 410c. A vacuum, is provided in areas 432 of piston arrangement 430 and in a space 478 between second magnet 428 and second structure 420. Any air or vacuum in space 478 may be vented out of space 478 through vents 480 when piston arrangement 430 causes second magnet 428 to move downward relative to z-axis 410c.

Magnets 424, 428 may vary widely in size. For example, magnet 424 may be smaller in a dimension relative to a y-direction 410b and in a dimension relative to an x-direction 410a than magnet 428. The dimensions may be selected such that when first structure 416 translates relative to y-direction 410b or x-direction 410a, a bottom surface of first magnet 324 is substantially always positioned over a top surface of second magnet 428.

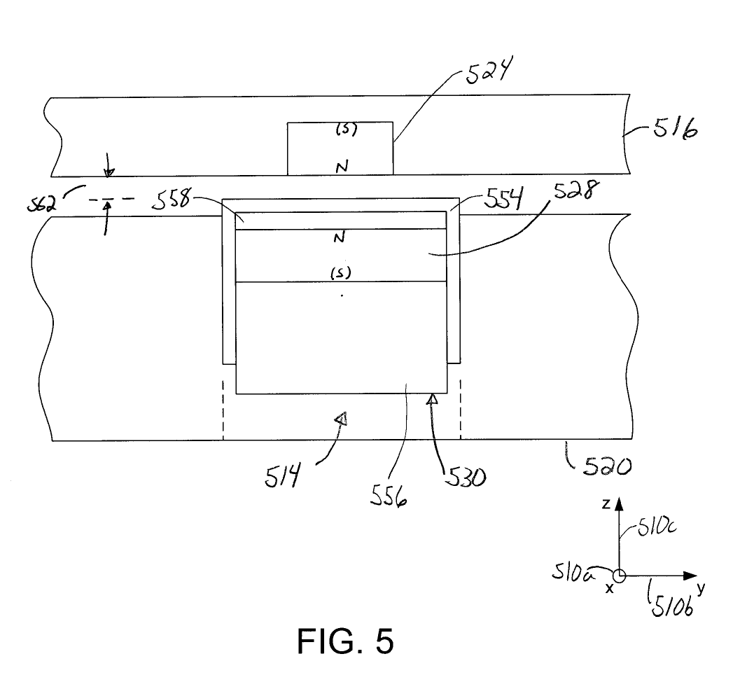

In lieu of first magnet 424 and second magnet 428 being separated by gap 460, first magnet 424 and second magnet 428 may instead be separated by a gap and a frame of a piston arrangement. FIG. 5 is a diagrammatic cross-sectional side-view representation of an anti-gravity device with a frame that separates a first magnet from a second magnet in accordance with an embodiment of the present invention. An anti-gravity device 514 includes a first magnet 524 and a piston arrangement 530. First magnet is coupled to a first structure 516 that is arranged to be positioned over a second structure 520. Piston arrangement 530, which is supported at least partially within second structure 520, includes a frame 554 and a piston 556. Piston 556 is arranged to translate relative to frame 554 in a z-direction 510c. Within piston arrangement 530, a second magnet 528 is supported on piston 556.

First magnet 524 and second magnet 528 are arranged to have opposing poles which repel each other. As shown, first magnet 524 and second magnet 528 have opposing north poles, although first magnet 524 and second magnet 528 may instead have opposing south poles. A vacuum is provided in a space 558 between second magnet 528 and frame 554. The vacuum provided in space 558 balances the repulsive force associated with first magnet 524 and second magnet 528. That is, when repulsive force is such that piston 530 is substantially pushed downward relative to z-direction 510c, the repulsive force is balanced by a vacuum force of an approximately equal magnitude. Hence, first structure 516 effectively floats above second structure 520 and, hence, above piston arrangement 514.

Frame 554 and first magnet 524 are separated by a gap 562. Typically, the height of gap 562 is chosen to provide sufficient clearance to enable first structure 516 to tilt, and to allow first structure to translate relative to an x-direction 510a and a y-direction 510b without being inhibited by frame 554.

As previously mentioned, an anti-gravity device that includes magnets as well as a piston arrangement may be used to support the weight of a fine stage in a vertical direction. Such an anti-gravity device may be used as a part of a stage apparatus which includes a fine stage that has up to approximately six degrees of freedom. In other words, an anti gravity device that includes magnets and a piston arrangement may support a fine stage which has up to approximately six degrees of freedom. Referring next to FIG. 6, a stage apparatus that includes a fine stage with up to approximately six degrees of freedom and an anti-gravity device with magnets and a piston arrangement will be described in accordance with an embodiment of the present invention. A stage apparatus 600 includes a coarse stage 620 and a fine stage 616. Fine stage 616 is arranged to support an object 618, e.g., a reticle or a wafer, and to precisely position object 618 after object 618 has been coarsely positioned. To coarsely position object 618, coarse stage 620 may translate or rotate relative to axes 610c in up to approximately six degrees of freedom using any number of actuators (not shown). As fine stage 616 is supported over coarse stage 620, when coarse stage 620 moves, fine stage 616 also moves.

To allow fine stage 616 to fine tune the position of object 618, actuators such as voice coil motors (VCMs) may be used. As shown, actuators 638 are arranged to allow fine stage 616 to be precisely positioned relative to a y-axis 610b. It should be appreciated that actuators 628, when differentially actuated, allow for a first degree of rotational motion of fine stage 616. Similarly, actuators (not shown) may be arranged to allow fine stage 616 to translate relative to an x-axis 610a, and to provide another degree of rotational motion.

Actuators 636, which may be VCMs, are coupled to coarse stage 620 and are arranged to provide forces which enable fine stage 616 to be actuated relative to a z-axis 610c. When differentially actuated, actuators 636 allow fine stage 616 to tilt and, as a result, provide for another rotational degree of freedom. Once fine stage 616 is positioned such that object 618 is at a desired location relative to z-axis 610c, actuators 636 are typically no longer used actively to provide forces. Instead, fine stage 616 is supported by an anti-gravity device 614 which includes a first magnet 624 that is substantially coupled to fine stage 616 and a second magnet 628 that is effectively coupled to coarse stage 620. Forces, as for example repulsive forces, between magnets 624, 628 balance with vacuum forces associated with anti-gravity device 614 to support fine stage 616 against forces of gravity.

In general, the orientation of an anti-gravity device that utilizes magnets and a piston arrangement may vary. For example, as shown in FIG. 7, a first magnet 724 of an anti-gravity device 714 that is substantially coupled to a first structure 716 that is positioned over a second structure 720 may be larger in dimensions along an x-axis 710a and a y-axis 710b than a second magnet 728. In general, one of magnets 724, 728 has larger dimensions than the other magnet 724, 728 relative to each horizontal axis along which first structure 716 is arranged to translate. Hence, either a second magnet such as second magnet 328 of FIG. 3 or first magnet 724 may have a larger dimension relative to a horizontal axis than their respective opposing magnets.

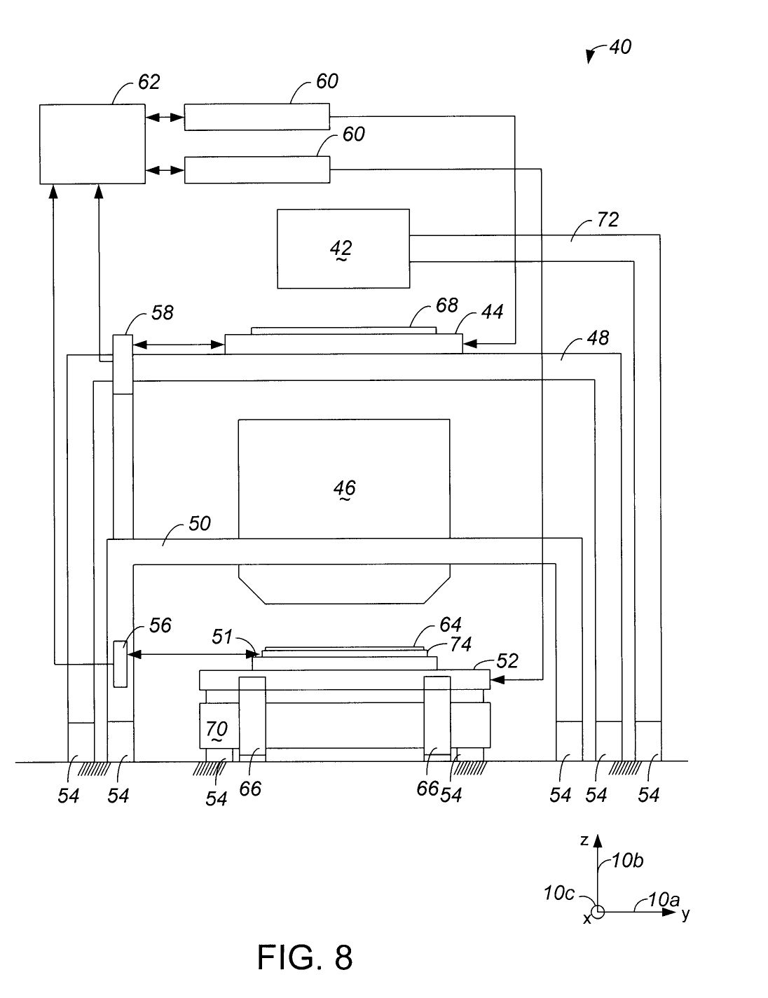

With reference to FIG. 8, a photolithography apparatus which may utilize an anti-gravity device that includes repelling magnets will be described in accordance with an embodiment of the present invention. A photolithography apparatus (exposure apparatus) 40 includes a wafer positioning stage 52 that may be driven by linear or a planar motors (not shown), as well as a wafer table 51 that is magnetically coupled to wafer positioning stage 52 by utilizing an EI-core actuator. The planar motor which drives or motors which drive wafer positioning stage 52 generally utilizes an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. In one embodiment, wafer positioning stage 52 may include a plurality of actuators which are coupled to a common magnet track. include a small counter mass, as described above. The movement of wafer positioning stage 52 allows wafer 64 to be positioned at a desired position and orientation relative to a projection optical system 46.

Wafer table 51 may be levitated in a z-direction 10b by any number of voice coil motors VCMs (not shown), e.g., three voice coil motors. Wafer table 51 may be supported in z-direction 10b by an anti-gravity device that includes a piston. In one embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Frame 72 may be part of a lens mount system of illumination system 42, and may be coupled to an active damper (not shown) which damps vibrations in frame 72 and, hence, illumination system 42. Illumination system 42 includes an illumination source, and is arranged to project a radiant energy, e.g., light, through a mask pattern on a reticle 68 that is supported by and scanned using a reticle stage 44 which includes a coarse stage and a fine stage. Either or both coarse stage and fine stage may be a monolithic reticle stage with up to six degrees of freedom. The radiant energy is focused through projection optical system 46, which is supported on a projection optics frame 50 and may be supported the ground through isolators 54. In one embodiment, projection optics frame 50 is coupled to an active damper (not shown) that is arranged to apply a variable force through a load point of projection optics frame in order to compensate for vibrational modes associated with projection optics frame 50. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46 optics frame 50, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer positioning stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i. e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

Further, the present invention may be utilized in an exposure apparatus that comprises two or more substrate and/or reticle stages. In such an apparatus, e.g., an apparatus with two substrate stages, one substrate stage may be used in parallel or preparatory steps while the other substrate stage is utilizes for exposing. Such a multiple stage exposure apparatus is described, for example, in Japan patent Application Disclosure No. 10-163099, as well as in Japan patent Application Disclosure No. 10-214783 and its U.S counterparts, namely U.S. Pat. No. 6,341,007, U.S. Pat. No. 6,400,441, U.S. Pat. No. 6,549,269, U.S. Pat. No. 6,590,634. Each of these Japan patent Application Disclosures and U.S. Patents are incorporated herein by reference in their entireties. A multiple stage exposure apparatus is also described in Japan patent Application Disclosure No. 20000-505958 and its counterparts U.S. Pat. No. 5,969,441 and U.S. Pat. No. 6,208,407, each of which are incorporated herein by reference in their entireties.

The present invention may be utilized in an exposure apparatus that has a movable stage that retains a substrate (wafer) for exposure, as well as a stage having various sensors or measurement tools, as described in Japan patent Application Disclosure No. 11-135400, which is incorporated herein by reference in its entirety. In addition, the present invention may be utilized in an exposure apparatus that is operated in a vacuum environment such as an EB type exposure apparatus and an EUVL type exposure apparatus when suitable measures are incorporated to accommodate the vacuum environment for air (fluid) bearing arrangements.

Further, in photolithography systems, when linear motors (see U.S. Pat. No. 5,623,853 or U.S. Pat. No. 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

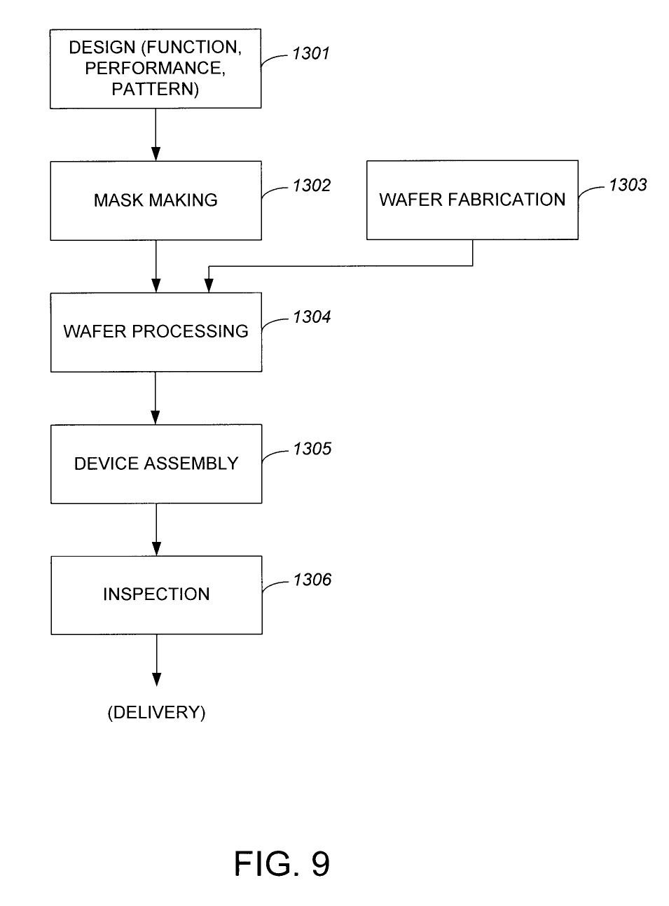

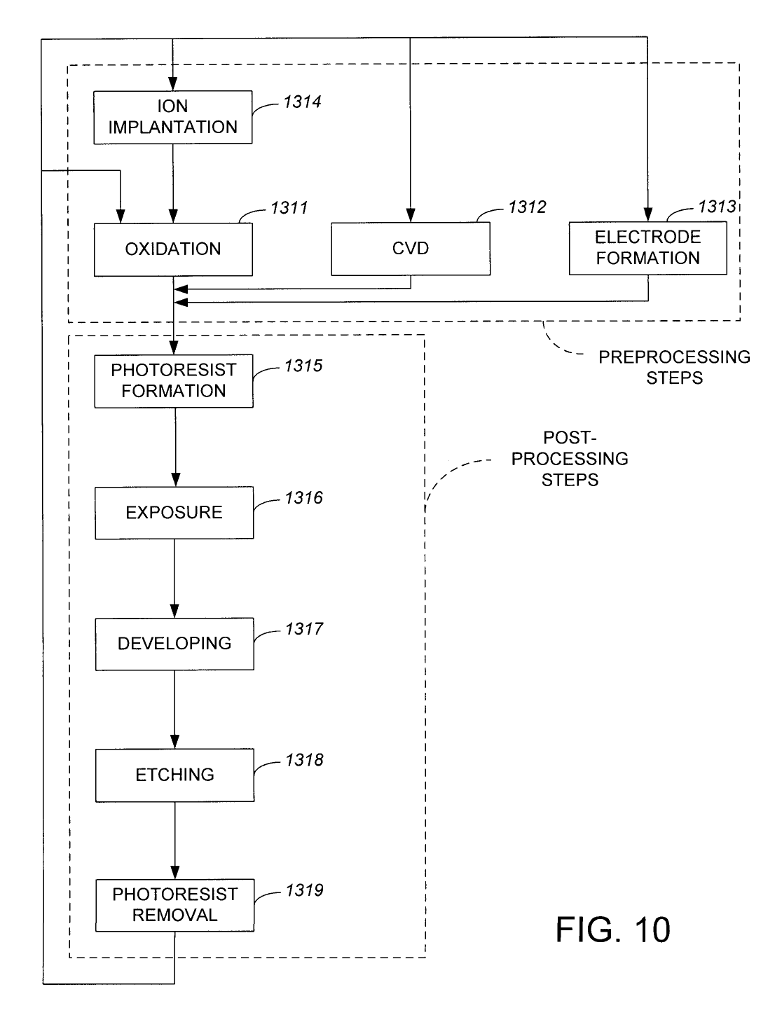

Further, semiconductor devices may be fabricated using systems described above, as will be discussed with reference to FIG. 9. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 10. In step 1305, the semiconductor device is assembled. The assembly of the semiconductor device generally includes, but is not limited to, wafer dicing processes, bonding processes, and packaging processes. Finally, the completed device is inspected in step 1306.

FIG. 9 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations. It should be appreciated that when the circuit pattern of the reticle is transferred to the wafer, an automatic reticle blind is generally in an open position to allow a laser beam to pass therethrough.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, an anti-gravity device with magnets and a piston has generally been described as being used to support the weight of a structure such as a fine stage. In addition to supporting the weight of a structure, an anti-gravity device may be used as an active deice to control the vertical position of the structure. For instance, the amount of vacuum used with an anti-gravity device may be controlled in order to control the vertical position of the structure.

In one embodiment, an active anti-gravity device with magnets and a piston may include an actuator such as a VCM that moves the piston to control the position of the piston and, hence, the position of a structure that is supported by the anti-gravity device. Such a VCM may be used to fine tune the position of the structure relative to a vertical position.

Damping mechanisms may be applied to a fine stage or a coarse stage to compensate for any vibratory motion that arises when either the fine stage or the coarse stage moves. Suitable damping mechanisms may include, but are not limited to, coils or dashpots.

Magnets of an anti-gravity device, though generally shown as blocks of magnetic material, may instead be composed of arrays of smaller magnets or blocks of magnetic material. For instance, in lieu of a first magnet being arranged as a single magnetic block, a first magnet may be composed of a plurality of magnets that are each arranged such that the poles of each of the plurality of magnets are aligned in substantially the same manner. It should be appreciated that some or all of the magnets may be electromagnets without departing from the spirit or the scope of the present invention.

An anti-gravity device that includes magnets and a piston arrangement may be used as a part of any suitable stage apparatus. Suitable stage apparatuses may include, but are not limited to, wafer scanning stage apparatuses used to position wafers and reticle scanning stage apparatuses used to position reticles. Additionally, as an anti-gravity device that includes magnets and a piston arrangement allows a fine stage to be supported over a coarse stage with substantially no mechanical couplings, a stage apparatus of which such an anti-gravity device is a part may include any number of fine stages which may be readily moved into position as appropriate. That is, a stage apparatus that uses anti-gravity devices of the present invention may be arranged such that multiple fine stages may be positioned over a single coarse stage to improve the overall throughput associated with the stage apparatus by enabling wafers, for instance, to be rapidly cycled through and positioned.

While an anti-gravity device of the present invention has generally been described as being suitable for use in stage apparatuses that include a fine stage and a coarse stage, an anti-gravity device may be used as a part of a variety of different apparatuses without departing from the spirit or the scope of the present invention. By way of example, an anti-gravity device that includes magnets and a piston arrangement may be used to provide anti-gravity support with relatively low transmissibility for a lens mount of a photolithography apparatus or for a mirror mount of an extreme ultraviolet lithography (EUVL) apparatus. Alternatively, if the magnets of an anti-gravity device are relatively large, the anti-gravity device may be arranged as a body isolation system. Therefore, the present examples are to be considered as illustrative and not restrictive, and the invention is not to be limited to the details given herein, but may be modified within the scope of the appended claims.

1. An apparatus comprising:
a first structure;
a second structure, the second structure having at least one associated air bearing; and
an anti-gravity device, the anti-gravity device including a first magnet and a piston arrangement that includes a second magnet, the first magnet being coupled to the first structure, the piston arrangement being movably interfaced with the second structure through the associated air bearing, wherein the first magnet and the piston arrangement cooperate to support the first structure over the second structure relative to a vertical axis.

2. The apparatus of claim 1 wherein the first magnet has a first magnet pole of a first polarity and the second magnet has a second magnet pole of the first polarity, the first magnet pole and the second magnet pole being arranged such that the first magnet pole opposes the second magnet pole and an overall repulsive force is associated with the first magnet and the second magnet.

3. The apparatus of claim 2 wherein the piston arrangement has an area, the area being substantially filled with a vacuum, the vacuum having a vacuum force, the vacuum force being arranged to balance the overall repulsive force to support the first structure over the second structure.

4. The apparatus of claim 1 wherein the first magnet has at least one horizontal dimension that is larger than at least one horizontal dimension of the second magnet.

5. The apparatus of claim 1 wherein the second magnet has at least one horizontal dimension that is larger than at least one horizontal dimension of the first magnet.

6. The apparatus of claim 1 wherein the piston arrangement includes a piston and the second magnet is coupled to the piston.

7. The apparatus of claim 1 wherein the apparatus is a stage apparatus, and wherein the first structure is a fine stage and the second structure is a coarse stage.

8. An exposure apparatus comprising the stage apparatus of claim 7.

9. A device manufactured with the exposure apparatus of claim 8.

10. A wafer on which an image has been formed by the exposure apparatus of claim 8.

11. A stage apparatus comprising:
a first stage arrangement, the first stage arrangement being arranged to support an object to be positioned;
a second stage arrangement, the second stage arrangement having at least one associated air bearing; and
an anti-gravity device, the anti-gravity device including a first magnet and a piston arrangement that includes a second magnet, the first magnet being coupled to the first stage arrangement, the piston arrangement being movably interfaced with the second stage arrangement through the associated air bearing, wherein the first magnet and the piston arrangement cooperate to support the first stage arrangement over the second stage arrangement relative to a vertical axis such that the first stage arrangement may move with the second stage arrangement and independently of the second stage arrangement.

12. The stage apparatus of claim 11 wherein the first magnet has a first magnet pole of a first polarity and the second magnet has a second magnet pole of the first polarity, the first magnet pole and the second magnet pole being arranged such that the first magnet pole opposes the second magnet pole and an overall repulsive force is associated with the first magnet and the second magnet.

13. The stage apparatus of claim 12 wherein the piston arrangement has an area, the area being substantially filled with a vacuum, the vacuum having a vacuum force, the vacuum force being arranged to balance the overall repulsive force to support the first stage arrangement over the second stage arrangement.

14. The stage apparatus of claim 11 wherein the first magnet has at least one horizontal dimension that is not equal to a corresponding horizontal dimension of the second magnet.

15. The stage apparatus of claim 11 wherein the first stage arrangement is arranged to move in up to six degrees of freedom substantially independently of the second stage arrangement.

16. An exposure apparatus comprising the stage apparatus of claim 11.

17. A device manufactured with the exposure apparatus of claim 16.

18. A wafer on which an image has been formed by the exposure apparatus of claim 16, wherein the object is the wafer.

19. A method for controlling a vertical position of a first stage arrangement relative to a second stage arrangement, the first stage arrangement be supported in a vertical direction over the second stage arrangement by an anti-gravity device, the anti-gravity device including a first magnet coupled to the first stage arrangement and a piston arrangement that includes a second magnet, the piston arrangement being movably interfaced with the second stage arrangement through an air bearing, the first magnet being arranged substantially above the second magnet, the method comprising:
generating a magnet force relative to the first magnet and the second magnet; and
generating a balancing force in response to the magnet force, wherein the balancing force and the magnet force cooperate to support the first stage arrangement over the second stage arrangement.

20. The method of claim 19 wherein the magnet force is a repulsive force and the balancing force is a vacuum force.

21. A method for operating an exposure apparatus comprising the method for controlling the vertical position of the first stage arrangement of claim 19.

22. A method for making an object including at least a photolithography process, wherein the photolithography process utilizes the method of operating an exposure apparatus of claim 21.

23. A method for making a wafer utilizing the method of operating an exposure apparatus of claim 21.
